(19) United States
(12) Patent Application Publication
(10) Pub. No.: US 2020/0247171 A1
(43) Pub. Date: Aug. 6, 2020

(54) ELECTRONIC FINGERPRINT MANAGEMENT SYSTEM AND METHOD FOR PREVENTING ARTWORK FORGERY/FALSIFICATION, METHOD FOR DETECTING FORGERY/FALSIFICATION OF ARTWORK, AND COMPUTER PROGRAM THEREFOR

(71) Applicant: Jin Young BYUN, Seoul (KR)

(72) Inventor: Jin Young BYUN, Seoul (KR)

(21) Appl. No.: 16/491,472

(22) PCT Filed: Mar. 2, 2018
(86) PCT No.: PCT/KR2018/002515

§ 371 Date: Mar. 17, 2020

(30) Foreign Application Priority Data
Mar. 7, 2017 (KR) 10-2017-0028837

(51) Int. Cl. B42D 25/313; B42D 25/355; B42D 25/36; B42D 25/20; H04W 12/00; G06Q 30/00

(52) U.S. Cl. CPC B42D 25/313; B42D 25/355; G06Q 30/0185; B42D 25/20; H04W 12/00407; B42D 25/36

(57) ABSTRACT

An electronic fingerprint management system for preventing artwork forgery/falsification comprises: a photographing unit configured to photograph a microstructure from a part of a material used or to be used for an artwork; a fingerprint extracting unit configured to generate, from the photographed microstructure, an electronic fingerprint including digital conversion information of the microstructure; and a fingerprint registering unit including a database and configured to generate a unique number corresponding to the electronic fingerprint, and associate the electronic fingerprint and the unique number with each other and register the same in the database. The present invention converts a microstructure of a material used or to be used for an artwork into an electronic fingerprint, and manages the same, so that it is impossible to forge an imitation as a genuine work by imitating the electronic fingerprint. Therefore, forgery issues concerning existing famous artworks can be resolved, and works of rising artists can be protected from danger of counterfeiting.

### TECHNICAL FIELD

Exemplary embodiments relate to a system and method for management of electronic fingerprint for preventing forgery or alteration of art pieces, a method for detecting forgery or alteration of art pieces and a computer program for the same. More particularly, exemplary embodiments relate to technology that converts a microstructure of a material used or to be used in an art piece into an electronic fingerprint, and prevents or detects forgery or alteration of the art piece using the electronic fingerprint.

### BACKGROUND ART

Art pieces having artistic and aesthetic elements such as paintings, calligraphic artworks, sculptures, handcrafts, architectures and musical instruments have different economic values and worth preserving depending on the corresponding art pieces' creators. Art pieces created by famous or unique creators have high economic value due to their quality and rarity, and sometimes such art pieces are forged so deliberately that it is difficult to distinguish between real and fake art pieces.

To identify fake art pieces and weed out them from genuine art pieces, it is necessary to perform a long-term authentication operation by experts in the corresponding field to identify genuine art pieces. However, in many cases, despite the authentication operation, a consistent authentication result may not be derived from each expert, and on rare occasions, even though art pieces are authenticated by experts, the results may be inaccurate, resulting in low reliability.

To overcome this drawback, recently emerging technology acquires attributes from an art piece using an imaging device and authenticates a target art piece using the attributes. However, authentication methods using equipment developed up to now are not so advanced in terms of the type of information or a detection process for authentication that it is not difficult to avoid them to forge art pieces, and management of genuine art pieces is accomplished separately from distribution of the materials of the art pieces, and thus art piece related information is not managed in an integrated and comprehensive manner.

For example, Patent Publication No. 10-2009-0032637 discloses creating fingerprint image data from an artwork and authenticating the artwork using the fingerprint image data. However, in Patent Publication No. 10-2009-0032637, the fingerprint image data indicates the fingerprint of an artist or an authenticator of the artwork, so there is a risk of fingerprint forgery, and even though the authenticator's fingerprint is not forged, it is difficult to ensure reliability. Additionally, the artist or authenticator needs to take time in putting fingerprints for each artwork, and it is inconvenient to manage the fingerprints, and besides, it is impossible to manage a variety of artists' artworks in an integrated and comprehensive manner.

### DISCLOSURE

### Technical Problem

According to an aspect of the present disclosure, there is provided a system and method for management of electronic fingerprint in which a microstructure of a material used or to be used in an art piece is converted into an electronic fingerprint and managed to prevent forgery and alteration of the art piece, a method for detecting forgery or alteration of art pieces using the electronic fingerprint and a computer program for the same.

### Technical Solution

A system for management of electronic fingerprint for preventing forgery or alteration of art pieces according to an embodiment comprises: an imaging unit configured to image a microstructure from a portion of a material used or to be used in an art piece; a fingerprint extraction unit configured to generate an electronic fingerprint including digital conversion information of the microstructure from the imaged microstructure; and a fingerprint registration unit including a database, the fingerprint registration unit configured to generate a unique number corresponding to the electronic fingerprint, and register the electronic fingerprint and the unique number being associated with each other in the database.

The system for management of electronic fingerprint for preventing forgery or alteration of art pieces according to an embodiment further comprises: a tag output unit configured to output a Near Field Communication (NFC) tag that is fixed to the material, wherein the electronic fingerprint and the unique number are recorded in the NFC tag.

In an embodiment, the imaging unit is configured to image the microstructure by irradiation of X-ray, ultrasonic wave or light of a preset brightness or more penetrating the material to a preset depth from a surface of the material.

In an embodiment, the digital conversion information of the microstructure includes a grid comprising a plurality of units each having a luminance value.

In an embodiment, the database is further configured to store encoded information of at least one of a location and size in which the microstructure is imaged, a size of the grid and a size of each unit of the grid.

In an embodiment, the system for management of electronic fingerprint for preventing forgery or alteration of art pieces further comprises: a communication unit configured to receive art piece information associated with the art piece from a user device, wherein the fingerprint registration unit is further configured to register the art piece information being associated with the electronic fingerprint and the unique number in the database.

A method for management of electronic fingerprint for preventing forgery or alteration of art pieces according to an embodiment comprises: imaging, by a system for management of electronic fingerprint, a microstructure from a portion of a material used or to be used in an art piece; generating, by the system for management of electronic fingerprint, an electronic fingerprint including digital conversion information of the microstructure from the imaged microstructure; generating, by the system for management of electronic fingerprint, a unique number corresponding to the electronic fingerprint; and registering the electronic fingerprint and the unique number being associated with each other in a database of the system for management of electronic fingerprint.

In an embodiment, the method for management of electronic fingerprint for preventing forgery or alteration of art pieces further comprises: outputting, by the system for management of electronic fingerprint, a Near Field Communication (NFC) tag that is fixed to the material, wherein the electronic fingerprint and the unique number are recorded in the NFC tag.

In an embodiment, imaging the microstructure comprises imaging the microstructure by irradiation of X-ray, ultrasonic wave or light of a preset brightness or more penetrating the material to a preset depth from a surface of the material.

In an embodiment, the digital conversion information of the microstructure includes a grid comprising a plurality of units each having a luminance value.

In an embodiment, registering in the database comprises storing encoded information of at least one of a location and size in which the microstructure is imaged, a size of the grid and a size of each unit of the grid in the database.

In an embodiment, the method for management of electronic fingerprint for preventing forgery or alteration of art pieces further comprises: receiving, by the system for management of electronic fingerprint, art piece information associated with the art piece from a user device; and registering, by the system for management of electronic fingerprint, the art piece information being associated with the electronic fingerprint and the unique number in the database.

A system for management of electronic fingerprint for preventing forgery or alteration of art pieces according to another embodiment comprises: a fingerprint registration unit including a database, wherein an electronic fingerprint including digital conversion information of a microstructure of a portion of a material used or to be used in an art piece and a unique number of the electronic fingerprint are associated with each other and stored in the database; a communication unit to receive information read from a material used in a target art piece or a Near Field Communication (NFC) tag fixed to the material; and a forgery and alteration detection unit configured to compare the information received by the communication unit with the information stored in the database, wherein the communication unit is further configured to transmit a result of the comparison by the forgery and alteration detection unit to a user device as information indicating authenticity of the target art piece.

In an embodiment, the information received by the communication unit includes the unique number read from the material.

In an embodiment, the information received by the communication unit includes at least one of the unique number and the electronic fingerprint read from the NFC tag.

In an embodiment, the database further stores art piece information associated with the electronic fingerprint and the unique number, the information received by the communication unit further includes art piece information read from the NFC tag, and the forgery and alteration detection unit is further configured to compare the art piece information read from the NFC tag with the art piece information stored in the database.

In an embodiment, the forgery and alteration detection unit is further configured to compare the electronic fingerprint read from the NFC tag with the electronic fingerprint stored in the database.

In an embodiment, the system for management of electronic fingerprint for preventing forgery or alteration of art pieces further comprises: an imaging unit configured to image a microstructure from a portion of the material used in the target art piece, wherein the forgery and alteration detection unit is further configured to compare the microstructure imaged by the imaging unit with the electronic fingerprint stored in the database.

A method for detecting forgery or alteration of art pieces according to another embodiment comprises: receiving, by a system for management of electronic fingerprint, information read from a material used in a target art piece or a Near Field Communication (NFC) tag fixed to the material; comparing the information received by the system for management of electronic fingerprint with information stored in a database of the system for management of electronic fingerprint, wherein an electronic fingerprint including digital conversion information of a microstructure of a portion of a material used or to be used in an art piece and a unique number of the electronic fingerprint are associated with each other and stored in the database; and transmitting a result of the comparison to a user device as information indicating authenticity of the target art piece.

In an embodiment, the receiving comprises receiving the unique number read from the material.

In an embodiment, the receiving comprises receiving at least one of the unique number and the electronic fingerprint read from the NFC tag.

In an embodiment, the database further stores art piece information associated with the electronic fingerprint and the unique number, the receiving comprises receiving art piece information read from the NFC tag, and the comparing comprises comparing the art piece information read from the NFC tag with the art piece information stored in the database.

In an embodiment, the comparing comprises comparing the electronic fingerprint read from the NFC tag with the electronic fingerprint stored in the database.

In an embodiment, the comparing further comprises: imaging a microstructure from a portion of the material used in the target art piece; and comparing the imaged microstructure with the electronic fingerprint stored in the database.

A computer program according to an embodiment is stored in a medium to perform the method for detecting forgery or alteration of art pieces according to the aforementioned embodiments in combination with hardware.

### Advantageous Effects

According to the system and method for management of electronic fingerprint and the method for detecting forgery or alteration of art pieces in accordance with an aspect of the present disclosure, a microstructure of a material used or to be used in an art piece is converted into an electronic fingerprint and managed to easily authenticate the art piece using the corresponding material.

In addition, according to an aspect of the present disclosure, electronic fingerprint related additional information such as a location or size in which the microstructure is extracted from the art piece material is encoded and registered in a server, and thus it is impossible that a third party, not a real artist, forges the art piece by copying the electronic fingerprint. Additionally, the server, in which the electronic fingerprint is stored, is impossible to access on-line, thereby improving security.

Further, using the electronic fingerprint according to an aspect of the present disclosure, the electronic fingerprint may be extracted from the material of not only a completed art piece but also a blank canvas and the material may be released with a unique number allocated thereto, and thus it is possible to register, search and manage art pieces in a comprehensive manner using big data technology. Accordingly, it is possible to eliminate the controversy over forgery of existing famous art pieces, and escape new artists' art pieces from forgery danger.

### DESCRIPTION OF DRAWINGS

FIG. 1 is a schematic block diagram of a system for management of electronic fingerprint for preventing forgery or alteration of art pieces according to an embodiment.

FIG. 2 is a flowchart showing each step of a method for management of electronic fingerprint for preventing forgery or alteration of art pieces according to an embodiment.

FIGS. 3A and 3B are images showing a digital conversion process for a microstructure of a material by a method for management of electronic fingerprint for preventing forgery or alteration of art pieces according to an embodiment.

FIGS. 4A to 4E are images showing each step of image processing of a microstructure of a material by a method for management of electronic fingerprint for preventing forgery or alteration of art pieces according to an embodiment.

FIG. 5 is a flowchart showing each step of a method for detecting forgery or alteration of art pieces according to an embodiment.

### MODE FOR INVENTION

Hereinafter, exemplary embodiments of the present disclosure will be described in detail with reference to the accompanying drawings.

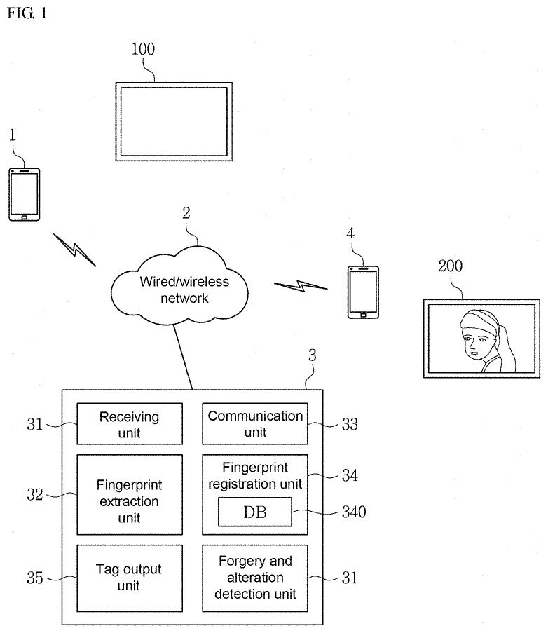

FIG. 1 is a schematic block diagram of a system for management of electronic fingerprint for preventing forgery or alteration of art pieces according to an embodiment.

Referring to FIG. 1, the system for management of electronic fingerprint according to the embodiment may operate while being connected to one or more user devices 1, 4 via a wired and/or wireless network, allowing communication therebetween. A method for communication via a wired and/or wireless network may include all communication methods that enables networking between objects, and is not limited to wired communication, wireless communication, 3G, 4G, 5G or other methods.

For example, communication methods via the wired and/or wireless network 2 include any communication method selected from the group consisting of Local Area Network (LAN), Metropolitan Area Network (MAN), Global System for Mobile Network (GSM), Enhanced Data GSM Environment (EDGE), High Speed Downlink Packet Access (HSDPA), Wideband Code Division Multiple Access (W-CDMA), Code Division Multiple Access (CDMA), Time Division Multiple Access (TDMA), Bluetooth, Zigbee, Wi-Fi, Voice over Internet Protocol (VoIP), LTE Advanced, IEEE802.16m, WirelessMAN-Advanced, HSPA+, 3GPP Long Term Evolution (LTE), Mobile WiMAX (IEEE 802.16e), UMB (formerly EV-DO Rev. C), Flash-OFDM, iBurst and MBWA (IEEE 802.20) systems, HIPERMAN, Beam-Division Multiple Access (BDMA), World Interoperability for Microwave Access (Wi-MAX) and ultrasonic communication, but is not limited thereto.

The system and apparatus according to embodiments may have aspects that are wholly in hardware, or partly in hardware and partly in software. The term “unit”, “module”, “server”, “system”, “platform”, “device” or “terminal” as used herein is intended to indicate a combination of hardware and software that runs by the corresponding hardware. For example, here, hardware may be a data processing device including a CPU or other processor. Additionally, software that runs by hardware may refer to a process in execution, an object, an executable, a thread of execution and a program.

A user device 1 is a device for a user who wants to register an electronic fingerprint of a material 100 used or to be used in an art piece. For example, the user of the user device 1 may be an artist who creates an art piece using the material 100, a seller of the material 100 or an electronic fingerprint registration agent. Additionally, a user device 4 is a device for a user who wants to authenticate a target art piece 200 using information read from a Near Field Communication (NFC) tag of the target art piece 200. For example, the user devices 1, 4 may be a smartphone with an NFC function. However, this is provided by way of illustration, and the user devices 1, 4 may be any other computing device such as a different type of mobile communication terminal, a notebook computer, personal digital assistant (PDA) and a tablet computer.

In an embodiment, the electronic fingerprint management system 3 may function as an application server at least in part to communicate with an application (or app) running on the user devices 1, 4 to enable the execution of the functions of the application. Alternatively/additionally, the electronic fingerprint management system 3 may function as a web server to provide a predetermined web page that can be accessed through a web browser running on the user devices 1, 4. The users may register an electronic fingerprint of the material 100 or check whether the target art piece 200 is genuine or not, by accessing the electronic fingerprint management system 3 using the user devices 1, 4.

In an embodiment, the electronic fingerprint management system 3 includes at least one functional unit. Each element of the electronic fingerprint management system 3 is not necessarily intended to indicate separate devices that are physically separated from each other. That is, each unit 31-36 shown in FIG. 1 is hardware that constitutes the electronic fingerprint management system 3, functionally divided according to the operation performed by the corresponding hardware, and each unit does not need to be provided independently of each other. Of course, according to embodiments, at least one of the units 31-36 shown in FIG. 1 may be implemented as separate devices that are physically separated from each other.

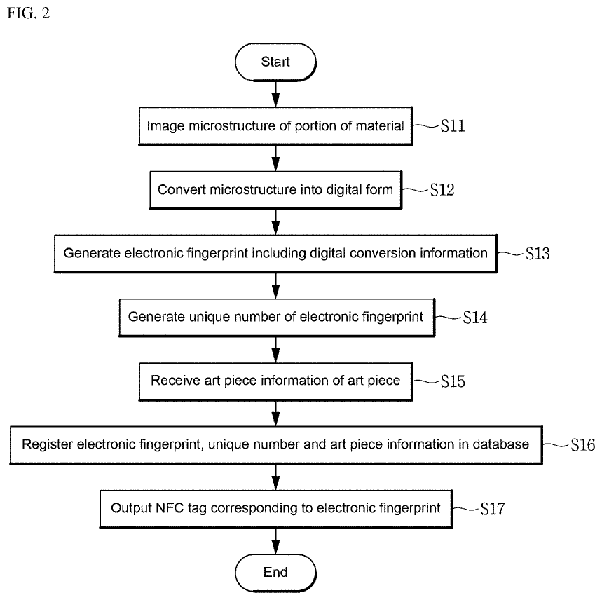

The operation of each unit 31-36 of the electronic fingerprint management system 3 and the user devices 1, 2 related to them will be described in detail with further reference to FIG. 2 below.

FIG. 2 is a flowchart showing each step of a method for management of electronic fingerprint for preventing forgery or alteration of art pieces according to an embodiment.

Referring to FIGS. 1 and 2, the electronic fingerprint management system 3 according to an embodiment for registering an electronic fingerprint using a material 100 of which the electronic fingerprint is not yet registered includes an imaging unit 31, a fingerprint extraction unit 32 and a fingerprint registration unit 34.

In the specification, the material refers to a material for creating an art piece, and for example, in the case of paintings, a canvas corresponds to the material. The canvas is mainly made of a cotton fabric or textile, and gesso or paint is selectively applied to the canvas and dried. The cotton fabric or textile is constructed with a combination of weft threads and warp threads, and due to twists of each thread, connected parts of cut threads or sparsity of threads, each canvas has different microstructures as if human fingerprints and there is no exact same shape and morphology. In this context, the present disclosure proposes technology that converts the microstructures of materials used or to be used in art pieces into electronic fingerprints and prevents forgery or alteration of the art pieces through the electronic fingerprints.

In the specification, the material is described on the basis of the canvas, but the material may be any object that has a unique microstructure for each product and can be converted into an electronic fingerprint, and is not limited to the canvas. For example, in the case of calligraphic artworks, a textile or a paper such as a handmade paper may correspond to the material, and in the case of ceramics artworks, clay or soil may correspond to the material.

To register an electronic fingerprint, first, the imaging unit 31 images the microstructure of a portion of the material 100 (S11). In this instance, the material 100 may be a pictorial canvas, or a pre-pictorial blank canvas. In the case of a blank canvas, strong light may be cast onto the rear surface of the canvas and the fibrous tissue of the illuminated canvas may be imaged by a high definition camera. On the other hand, in the case of a pictorial canvas, when simply imaged, pigments on the canvas are seen rather than the microstructure of the canvas, and the microstructure may be imaged in a nondestructive way by focusing X-rays or ultrasound onto the fibrous tissue of the canvas itself, not pigments, such that the X-rays or ultrasound penetrate to a preset depth from the canvas surface.

Alternatively, according to the material of the canvas, the microstructure of the fibrous tissue of the canvas may be imaged by setting the brightness of light to a preset value or above without using X-rays or ultrasound. In this instance, the light refers to visible light. For example, the fibrous tissue of the canvas may be imaged by casting strong light of at least 10,000 lux corresponding to the solar daylight brightness. However, the brightness of light for imaging the microstructure is not limited thereto.

In addition to the canvas, the above-described principle may be similarly applied to different art piece materials such as handmade papers or soil.

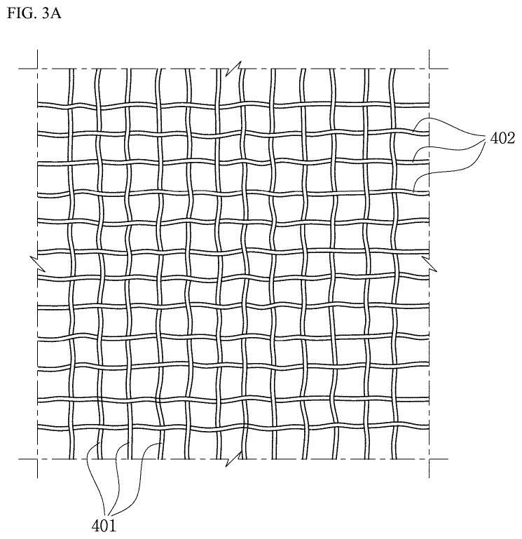

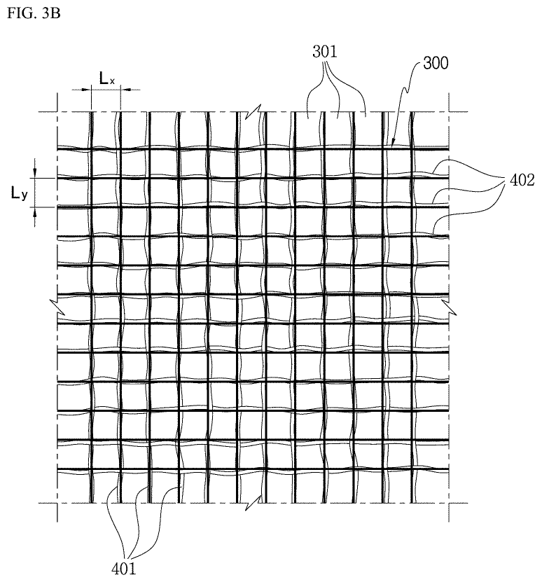

The fingerprint extraction unit 32 performs digital conversion of the microstructure imaged by the imaging unit 31 to convert the microstructure to an electronic fingerprint (S12). FIGS. 3A and 3B are images showing the digital conversion process for the microstructure of the material by a method for management of electronic fingerprint for preventing forgery or alteration of art pieces according to an embodiment, and the digital conversion step S12 will be described in detail with further reference to FIGS. 3A and 3B.

Referring to FIG. 3A, the cotton fabric or textile of which the canvas is made includes a plurality of weft threads 401 and a plurality of warp threads 402 crossing each other. In this instance, a combination of the weft thread 401 and the warp thread 402 has a unique shape for each part due to twists of each thread, connected parts of cut threads, sparsity or looseness of threads, or impurities. In this instance, referring to FIG. 3B, the fingerprint extraction unit 32 digitalizes the microstructure of the canvas by generating a grid 300 having a plurality of units 301 to match the shape of the weft threads 401 and the warp threads 402 crossing each other. Each unit 301 of the grid 300 has a specific luminance value. That is, the grid 300 has a structure similar to a bitmap image having the unit 301 as one unit pixel.

Due to the irregular shape of the weft threads 401 and the warp threads 402 crossing each other, the luminance of each unit 301 of the grid 300 is different from each other. For example, when microstructure imaging is performed on the front surface of the canvas while casting strong light from the rear surface of the canvas, in case that the weft threads 401 or the warp threads 402 cover a larger area within the unit 301, the corresponding unit 301 will look darker since light is blocked by the weft threads 401 or the warp threads 402. On the contrary, in case that the weft threads 401 or the warp threads 402 go through a smaller area within the unit 301, a larger amount of light passes from the rear surface of the canvas to the front surface, and thus the unit 301 will look brighter.

Accordingly, the irregular shape of the weft threads 401 and the warp threads 402 crossing each other may be converted into digital information by calculating a luminance value of the area corresponding to each unit 301 of the grid 300 in the imaged microstructure. That is, here, the digital conversion information refers to a unique luminance pattern obtained by the irregular shape of the weft threads 401 and the warp threads 402 crossing each other. The imaged microstructure may be an image having a plurality of pixels, and in this instance, the luminance value of each unit 301 of the grid 300 may be the sum of luminance values of pixels located within the area corresponding to the unit 301 or an average luminance value of the corresponding pixels.

For example, when the grid 300 is an array of units 301 including five rows and five lines, the digital conversion information of the microstructure may be as shown in the following Table 1.

TABLE 1

| | | | | |
|---|---|---|---|---|
| 51 | 49 | 46 | 48 | 46 |
| 50 | 52 | 53 | 41 | 50 |
| 40 | 59 | 66 | 41 | 39 |
| 53 | 55 | 62 | 38 | 55 |
| 52 | 50 | 63 | 52 | 50 |

In an embodiment, to increase reliability of electronic fingerprint comparison and simplify calculation in the process of detecting forgery or alteration to be performed later, the luminance value of each unit 301 of the grid 300 may be compared with a preset reference value, and the luminance value of each unit 301 may be converted into a binary number according to whether the corresponding luminance value is equal to or higher than the reference value or is less than the reference value. For example, when the luminance value of the unit 301 is equal to or higher than the reference value, the luminance value may be converted into 1, and when the luminance value of the unit 301 is less than the reference value, the luminance value may be converted into 0.

The reference value for binary conversion of digital conversion information may be determined using a specific fixed luminance value or luminance values of pixels belonging to the grid 300. For example, the reference value may be an average luminance value of all the units 301 belonging to the grid 300.

When it is assumed that the reference value for binary number conversion is 50 in the digital conversion information of the microstructure shown in Table 1, the digital conversion information of Table 1 may be simplified as a binary pattern as shown in the following Table 2.

TABLE 2

| | | | | |
|---|---|---|---|---|
| 1 | 0 | 0 | 0 | 0 |
| 1 | 1 | 1 | 0 | 1 |
| 0 | 1 | 1 | 0 | 0 |
| 1 | 1 | 1 | 0 | 1 |
| 1 | 1 | 1 | 1 | 1 |

For simplification of description, the grid 300 having a simple structure of 5×5 has been hereinabove described, but it will be easily understood that the shape of the grid 300 is not actually limited thereto. When the size of the microstructure for obtaining an electronic fingerprint is set to be enough large and the size of each unit 301 to be included in the grid 300 corresponding to the corresponding microstructure is set to be enough small, the unique shapes formed in each area of the canvas by the irregular shape of the weft threads 401 and the warp threads 402 crossing each other may be converted into unique digital information. That is, areas having different microstructures in the material have different digital conversion information.

To this end, in an embodiment, to reflect the unique pattern of the corresponding microstructure well with reference to the imaged microstructure, the horizontal length Lₓ and/or the vertical length L_{y} of each unit 301 of the grid 300 is determined. As described above, an area in which the weft threads 401 and the warp threads 402 are located in the microstructure looks darker since light coming from the rear surface of the canvas is blocked. Accordingly, the weft threads 401 and the warp threads 402 may be detected by detecting an area in which there is a rapid change in pixel luminance in the imaged microstructure. This detection process can be easily understood by those skilled in the art from known image processing technology and its detailed description is omitted herein.

In this instance, the fingerprint extraction unit 32 may detect a plurality of weft threads 401 located within the imaged microstructure, and determine the horizontal length Lₓ of each unit 301 of the grid 300 in consideration of the distance between adjacent weft threads 401 and the thickness of each weft thread 401. For example, the horizontal length Lₓ of each unit 301 of the grid 300 may be a value obtained by adding an average distance between adjacent weft threads 401 to an average thickness of each weft thread 401. Likewise, the fingerprint extraction unit 32 may detect a plurality of warp threads 402 located within the imaged microstructure, and determine the vertical length L_{y} of each unit 301 of the grid 300 in consideration of the distance between adjacent warp threads 402 and the thickness of each warp thread 402. For example, the vertical length L_{y} of each unit 301 of the grid 300 may be a value obtained by adding an average distance between adjacent warp threads 402 to an average thickness of each warp thread 402.

According to this embodiment, the grid 300 and the unit 301 are set to reflect the feature of the corresponding microstructure through image processing of the imaged microstructure. For example, the grid 300 may be generated such that one spacing of a grid formed by the weft threads 401 and the warp threads 402 crossing each other approximately corresponds to one unit 301. As the generated grid 300 reflects the entire feature of the microstructure of the canvas, and the unique shape of the microstructure in the form of the luminance value of each unit 301 of the grid 300, the unique microstructure of the canvas may be converted into unique digital information.

However, this is provided by way of illustration, and in another embodiment, digital conversion information may be obtained by applying a grid having units of a fixed size without a separate image processing process for the microstructure. In still another embodiment, digital conversion information may be obtained by randomly setting the total size of the grid and/or the size of each unit of the grid.

Additionally, in an embodiment, an electronic fingerprint may be obtained by performing image processing for posterization before digital information conversion for the image of the microstructure, and performing the digital conversion process of FIGS. 3A and 3B on the posterized image. The posterization refers to a process of increasing a contrast value between each pixel of an image to ease the digital conversion of the image, and this effect is well known as the function of known image processing programs.

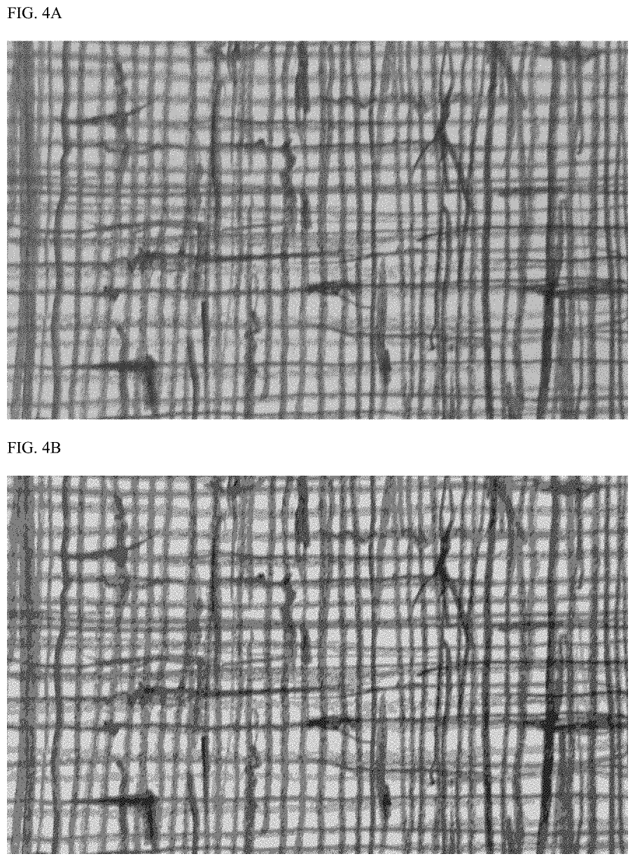

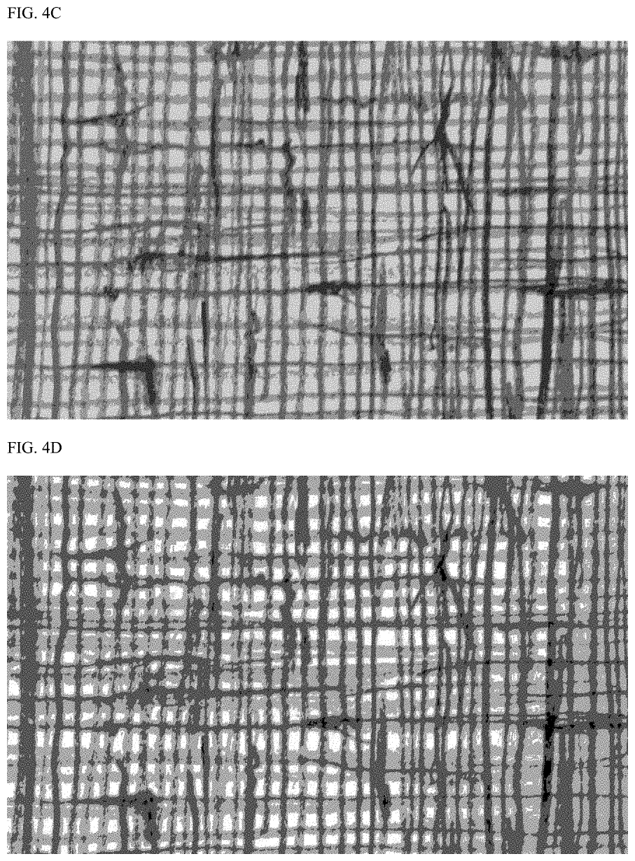

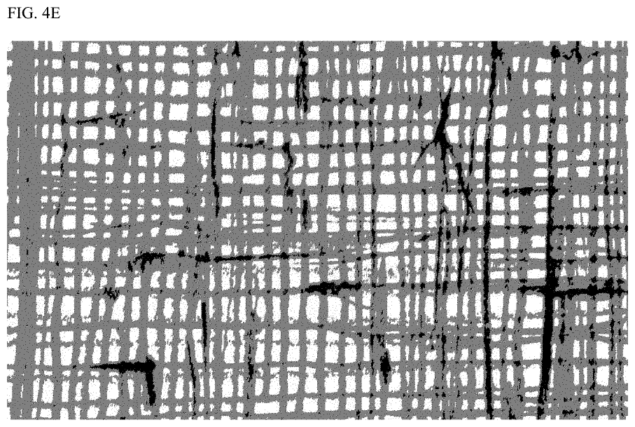

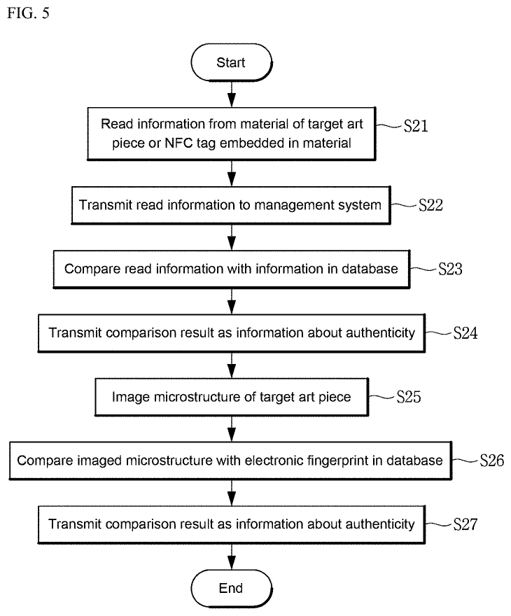

FIGS. 4A to 4E are images showing each step of image processing of microstructure of a material by a method for management of electronic fingerprint for preventing forgery or alteration of art pieces according to an embodiment.

FIG. 4A shows an original image of the microstructure, and FIGS. 4B to 4E show posterized images in steps 1, 2, 3 and 4 respectively. As shown, each time the posterization effect is given, contrast uniformity of the microstructure of the image is gradually emphasized, and accordingly, an electronic fingerprint reflecting the feature of the microstructure well may be obtained by performing digital conversion using the posterized image. However, this is not intended to limit the scope of the present disclosure, and according to embodiments, an electronic fingerprint may be obtained by digital conversion of the original image of the microstructure without posterization.

Although FIGS. 3A to 4E describes the digital conversion process for the microstructure of the material, taking the canvas composed of the weft threads 401 and the warp threads 402 crossing each other as an example, it will be easily understood by those skilled in the art that the same principle may be applied to a different material having a different weave structure.

That is, the weft threads 401 and the warp threads 402 correspond to a factor that causes a change in luminance value in the microstructure of the canvas, and in the above-described embodiment, using this, the grid 300 corresponding to the microstructure is set and the luminance pattern of the units 301 is obtained as digital conversion information. However, in another embodiment, the grid and the unit corresponding to the microstructure may be set using any other factor that causes a change in luminance value in the material such as the texture of a scroll, the laminated (combined) condition of a handmade paper and agglomeration of soil or clay in the same way as the weft threads 401 and the warp threads 402 of the above-described embodiment. Accordingly, the shape of the grid 300 is not limited to the grid shape shown in FIG. 3, and the grid of different shapes may be set depending on the weave structure of the material.

Additionally, in the material, the factor that causes a change in luminance value is not limited to those in the visible range. When the material is a material that disallows visible light to penetrate, such as pictorial canvas, scrolls or ceramics, the microstructure of the material is imaged by allowing X-rays or ultrasound to penetrate to a predetermined depth from the material surface. In this instance, the factor that causes a change in luminance value in the material may indicate any weave structure that causes a change in absorbance of X-rays or ultrasound.

Referring back to FIGS. 1 and 2, the fingerprint extraction unit 32 generates an electronic fingerprint including the digital conversion information of the microstructure (S13). Additionally, the fingerprint extraction unit 32 generates a unique number corresponding to the generated electronic fingerprint (S14). The unique number is a certain figure and/or character string allocated to the material 100 of which the electronic fingerprint is generated, and using the unique number, it is possible to manage the distribution of the material 100 and the creation activity or transaction details of the art piece using the material 100.

Subsequently, the fingerprint registration unit 34 registers the electronic fingerprint and the unique number obtained by the fingerprint extraction unit 32 in a database 340 of the fingerprint registration unit 34 (S16). For example, when a blank canvas is released, the fingerprint registration unit 34 may register the electronic fingerprint, the unique number, the type, the transaction date and the size corresponding to the corresponding canvas in the database 340. The electronic fingerprint registered in the database 340 may correspond to only an area of the material 100, or the electronic fingerprint of the entire area of the material 100 may be registered by dividing the material 100 into a plurality of areas, and registering all electronic fingerprints of each divided area in the database 340.

In an embodiment, the database 340 of the fingerprint registration unit 34 further stores additional information such as a location and size in which the microstructure is imaged from the material 100 to obtain the electronic fingerprint, the size of the grid 300, and/or the size of each unit 301 included in the grid 300. The additional information is encoded through a predefined encoding protocol to allow only the electronic fingerprint management system 3 to decode, thereby fundamentally eliminating the likelihood that a third party having no authority for the electronic fingerprint copy the electronic fingerprint.

For example, the imaging unit 31 images the microstructure of a specific size from a specific location of the material 100. For example, the microstructure may be imaged from a square that is 5 cm in horizontal and vertical size, ranging from the top left corner of the material 100 to 5 cm right and 5 cm down. In this instance, the fingerprint registration unit 34 may encode and store the location at which the microstructure is imaged and the size of the microstructure. Accordingly, even though a third party steals the electronic fingerprint, it is impossible to forge the microstructure of the genuine art piece so long as the third party does not know the microstructure was obtained at which location in which size. For example, when the location and size in which the microstructure is imaged is randomly changed each time the electronic fingerprint is obtained, a third party cannot forge the art piece because he/she cannot know the electronic fingerprint is located in which portion of the material in which size even though the corresponding electronic fingerprint is stolen.

The same principle may be equally applied to the total size of the grid 300 generated corresponding to the microstructure and the size of each unit 301 included in the grid 300. That is, the total size of the grid 300 and the size of each unit 301 included in the grid 300 may be encoded as additional information of the electronic fingerprint and stored in the database 340.

In an embodiment, the information registered in the database 340 of the fingerprint registration unit 34 may be encoded. Additionally, the database 340 of the fingerprint registration unit 34 may be implemented as a stand-alone server that is impossible for an external device to access on-line, or may be separately implemented as a primary server that is possible for an external device to access on-line and a secondary server that is impossible to an external device to access on-line, to protect electronic fingerprint information from a security threat by hacking. For example, the database 340 of the fingerprint registration unit 34 is necessarily configured to register or modify information only using information received from a medium connected through a direct connect interface such as USB, to fundamentally prevent being hacked via a network. Further, the database 340 of the fingerprint registration unit 34 may be further configured to prevent potential malicious database manipulation by automatically performing a virus or malware testing on a medium when connecting to the corresponding medium through a direct connect interface.

Meanwhile, the database 340 of the fingerprint registration unit 34 may not only register the electronic fingerprint and the unique number, but also store the image of the microstructure as shown in FIGS. 4A to 4E. In this case, in the forgery or alteration detection to be performed later, when it is not easy to detect forgery or alteration using the unique number and/or the electronic fingerprint or when a satisfactory result is not derived, forgery or alteration detection may be performed using the image of the microstructure. The process of detecting forgery or alteration using the stored image may be performed by known image processing methods, and to this end, an image to be stored in the database 340 may be a posterized image as shown in FIG. 4E, but is not limited thereto.

In an embodiment, the electronic fingerprint management system 3 further includes a communication unit 33. The communication unit 33 may receive art piece information of the art piece using the material 100 of which the microstructure is imaged from the user device 1 (S15), and the received art piece information may be stored in the database 340 of the fingerprint registration unit 34 together with the electronic fingerprint and the unique number of the material 100 in the step S16 described above. The art piece information may include, but is not limited to, the artist name, the creation date, the details, the title, the material, the type, the transaction date, the size, the brief description and the exhibition details of the art piece.

However, when the material 100 of which the microstructure is imagined is a blank canvas with no content, only an electronic fingerprint and a unique number of the canvas may be registered in the database 340 first, and information of an art piece created using the corresponding canvas may be registered later. In this case, the canvas is released as a product in blank state after its electronic fingerprint and unique number are registered in the database 340, and after buying the corresponding canvas, an artist may input art piece information in the electronic fingerprint management system 3 in person or through an agent at an arbitrary point in time during or after the creation of an art piece. For example, in this case, the art piece information may further include the artist's intent or comments about the art piece inputted by the artist. Through the foregoing process, it is possible to manage the history of the art piece through the electronic fingerprint management system 3 from the distribution stage of the material prior to the art piece.

In an embodiment, the electronic fingerprint management system 3 further includes a tag output unit 35. The tag output unit 35 outputs an NFC tag in which information corresponding to the electronic fingerprint is recorded (S17). In the specification, the output of the NFC tag may indicate printing the NFC tag on a paper such as a film, or generating information to be recorded in the NFC tag and transmitting the information so that the NFC tag may be printed using the user device 1 or other device.

The user having registered the electronic fingerprint of the material 100 may fix the NFC tag, in which information corresponding to the electronic fingerprint is recorded, to the material 100. For example, the user may cut off a portion of the inner part of the wood frame not to damage the canvas and embed the NFC tag therein, or may attach the NFC tag to the surface of the canvas. Additionally, a unique number or an indication of the electronic fingerprint may be imprinted at the location in which the NFC tag is embedded. The NFC tag may be fixed to art piece materials other than the canvas, for example, scrolls, handmade papers and ceramics, in a similar way. The fixed NFC tag may be used for an artist who buys a blank canvas and makes art on the canvas to register art piece information in the electronic fingerprint management system 3, or may be used to authenticate the art piece by reading from the target art piece 200.

The information recorded in the NFC tag may be all or some of the information registered in the database 340 in relation to the material 100 of which the microstructure is imaged. For example, the database 340 of the electronic fingerprint management system 3 may register all the electronic fingerprints of the entire area of the material 100, and the NFC tag may record the electronic fingerprint corresponding to only the specific area of the material 100. Accordingly, even though a third party succeeds in obtaining the electronic fingerprint by decoding the information recorded in the NFC tag and forges the art piece, it is possible to detect forgery by obtaining electronic fingerprints from the entire area of the forged article, and comparing with the electronic fingerprints of the entire area registered in the database 340. Additionally, the information recorded in the NFC tag may include the image of the microstructure converted into the electronic fingerprint as described above with reference to FIGS. 4A to 4E.

Additionally, the information recorded in the NFC tag art may include art piece information related to the art piece, for example, the artist name, the creation date, the details, the title, the material, the type, the transaction date, the size, the brief description and the exhibition details. When the art piece information is recorded in the NFC tag, it is possible to detect forgery or alteration using the information of the NFC tag, and besides, when the art piece is displayed, an audience can see the art piece information by tagging the NFC tag using the audience's device such as a smartphone.

Further, the information recorded in the NFC tag may include additional information, for example, the location and size in which the microstructure is imaged from the material 100, the size of the grid 300, and/or the size of each unit 301 included in the grid 300.

In an embodiment, the unique number for the electronic fingerprint of the material 100 is recorded in the material 100. It is desirable to record the unique number at an unseparable location in the material 100 so that the unique number is always found during the distribution of the art piece using the material 100. For example, in the case of the canvas, the unique number may be imprinted at a specific location in the wood frame of the canvas, not the cotton fabric. Alternatively, the artist or other person may paint the unique number on the cotton fabric of the canvas. For example, the artist may paint on the front surface of the canvas, and input the unique number on the rear surface of the canvas.

Additionally, the unique number may be imprinted or recorded at multiple locations in the material 100, and thus even though the unique number at any one location is damaged, the unique number may be recognized from any other location. Additionally, in case that the unique numbers at a plurality of locations are all damaged, even if the process of detecting forgery or alteration using the unique number is not performed, it may be suspected that the unique numbers were maliciously damaged by someone, and accordingly, imprinting or recording the unique number at a plurality of locations is advantageous.

According to this embodiment, even though the NFC tag embedded in the material 100 is lost or maliciously removed during the distribution of the art piece using the material 100, it is possible to detect forgery or alteration by comparing with the information of the database 340 using the unique number imprinted or inputted in the material 100 itself. The process of detecting forgery or alteration will be described in detail below.

FIG. 5 is a flowchart showing each step of a method for detecting forgery or alteration of art pieces according to an embodiment.

Referring to FIGS. 1 and 5, the electronic fingerprint management system 3 according to an embodiment for detecting forgery or alteration in a target art piece 200 that is not yet authenticated includes a communication unit 33, a fingerprint registration unit 34 and a forgery and alteration detection unit 36.

The user who wants to authenticate the target art piece 200 may read information from the material of the target art piece 200 or the NFC tag fixed to the material of the art piece 200 (S21), and transmit the read information to the communication unit 33 of the electronic fingerprint management system 3 (S22). For example, the read information may be information inputted after the user identifies the unique number imprinted in the material of the target art piece 200, or information read from the NFC tag fixed to the target art piece 200.

In the case of reading the NFC tag, the user may read information from the NFC tag using the user device 4, and transmit the read information from the user device 4 to the communication unit 33. However, this is provided by way of illustration, and a process of reading the NFC tag may be performed using a reader (not shown) provided in the electronic fingerprint management system 3, and in this case, the communication unit 33 may receive the information read from the NFC tag from the reader. Accordingly, in this case, the steps S21 and S22 may be omitted.

The forgery and alteration detection unit 34 compares the information read from the material of the art piece 200 or the NFC tag fixed to the material with the information registered in the database 340 of the fingerprint registration unit 34 (S23). Authentication for detecting forgery or alteration may be performed multiple times depending on the type of information being compared.

As first authentication, the forgery and alteration detection unit 34 may compare the unique number read from the material of the art piece 200 or the NFC tag fixed to the material with the unique number registered in the database 340. For example, when the unique number read from the material of the target art piece 200 or the NFC tag fixed to the material is not registered in the database 340 of the electronic fingerprint management system 3, it may be determined that there is a high likelihood that the target art piece 200 may be fake.

In the first authentication, when art piece information is recorded in the NFC tag and the database 340, the art piece information may be further utilized. For example, in comparing the unique number and the art piece information read from the NFC tag of the target art piece 200 with the corresponding information of the database 340, when the unique number read from the NFC tag is registered in the database 340 but the art piece information registered in the database 340 is different from the information read from the NFC tag, or when the art piece information read from the NFC tag is registered in the database 340 but the unique number registered in the database 340 is different from the unique number read from the NFC tag, it may be determined that there is a high likelihood that the target art piece 200 may be fake.

As second authentication, the forgery and alteration detection unit 34 may compare the electronic fingerprint read from the NFC tag with the electronic fingerprint registered in the database 340. The process of comparing the electronic fingerprints includes decoding the location and size in which the microstructure is imaged, the size of the grid and the size of each unit of the grid, encoded and stored in the database 340, and comparing the electronic fingerprints using the same. When the digital conversion information of the microstructure read from the NFC tag of the target art piece 200 is different from the electronic fingerprint registered in the database 340, it may be determined that there is a high likelihood that the target art piece 200 may be fake.

In an embodiment, when the electronic fingerprint read from the NFC tag is multiple obtained from different areas of the material, each of the plurality of electronic fingerprints read from the NFC tag is compared with the electronic fingerprint of the same area registered in the database 340, and when any one of the plurality of electronic fingerprints read from the NFC tag is different from the electronic fingerprint of the same area registered in the database 340, it may be determined that there is a high likelihood that the target art piece 200 may be fake.

Subsequently, the forgery and alteration detection unit 34 transmits the result of the above-described comparison to the user device 4 as information about authenticity of the target art piece 200 (S24). Accordingly, the user of the user device 4 may easily authenticate the target art piece 200 through the above-described process.

As a part of the second authentication process, when the image of the microstructure as shown in FIGS. 4A to 4E is registered in the NFC tag and the database 340, the forgery and alteration detection unit 34 may authenticate the target art piece 200 by determining if the microstructure image read from the NFC tag matches the microstructure image registered in the database 340. The image matching process may be performed by image processing through a computer, and for the purpose of easiness, the microstructure image registered in the NFC tag and the database 340 may be a posterized image.

Meanwhile, as third authentication, for additional authentication that does not rely on the electronic fingerprint of the NFC tag, in an embodiment, the electronic fingerprint management system 3 further includes the imaging unit 31. The imaging unit 31 images the microstructure of the target art piece 200 (S25). The process of imaging the microstructure may be the same as the step of imaging the microstructure (S11) of the embodiment shown in FIG. 2, and its detailed description is omitted in this embodiment.

Subsequently, the forgery and alteration detection unit 34 may compare the microstructure imaged by the imaging unit 31 with the electronic fingerprint registered in the database 340 (S26). The comparison process may include converting the microstructure imaged by the imaging unit 31 into an electronic fingerprint, and comparing the converted electronic fingerprint with the electronic fingerprint registered in the database 340. The third authentication is preferably performed by obtaining a plurality of electronic fingerprints from the entire area of the material used in the target art piece 200, but is not limited thereto.

In relation to the third authentication, the process of imaging by the imaging unit 31 and the process of converting the imaged microstructure into the electronic fingerprint may be performed using the location and size in which the microstructure is imaged, the size of the grid and/or the size of each unit included in the grid, registered in the NFC tag or the database 340 as additional information associated with the electronic fingerprint. For example, third authentication may be performed by identifying the additional information associated with the electronic fingerprint of the target art piece 200 by searching the database 340 using the unique number identified from the material of the target art piece 200 or the NFC tag, imaging the material of the target art piece 200 at the same location as the location at which the electronic fingerprint was registered, converting into the electronic fingerprint by the same method as the previous method, and comparing it with the electronic fingerprint registered in the database 340.

In the same way as the first and second authentication, the forgery and alteration detection unit 34 may transmit the result of the above-described comparison to the user device 4 as information about authenticity of the target art piece 200 (S27).

According to the system and method for management of electronic fingerprint and the method for detecting forgery or alteration of art pieces according to the embodiments as described above, the microstructure of a material used or to be used in an art piece is converted into an electronic fingerprint and managed to easily authenticate the art piece using the corresponding material, and as the electronic fingerprint has encoded related information such as a location or size in which the microstructure is extracted from the material of the art piece, it is impossible that a third party forges the art piece by copying the electronic fingerprint. Using the electronic fingerprint according to the above-described embodiments, it is possible to register, search and manage art pieces in a comprehensive manner using big data technology, and eliminate the controversy over forgery of existing famous art pieces, and escape new artists' art pieces from forgery danger.

Meanwhile, the method for management of electronic fingerprint or the method for detecting forgery or alteration of art pieces according to the embodiments as described hereinabove may be at least partially implemented as a computer program and recorded in computer-readable recording media. The program for implementing the method for management of electronic fingerprint or the method for detecting forgery or alteration of art pieces is recorded in the recording media according to the embodiments, and the recording media includes any type of recording device in which computer-readable data can be stored. For example, the computer-readable recording media includes ROM, RAM, CD-ROM, magnetic tape, floppy disk, and optical data storing devices. Additionally, the computer-readable recording media is distributed over computer systems connected via a network so that computer-readable codes may be stored and executed in distributed manner. Additionally, functional programs, codes and code segments for realizing this embodiment will be easily understood by those having ordinary skill in the technical field to which this embodiment belongs.

The present disclosure has been hereinabove described with reference to the embodiments shown in the accompanying drawings, but this is for illustration only and those having ordinary skill in the art will appreciate that various modifications may be made to the embodiments. However, it should be noted that such modifications fall in the scope of technical protection of the present disclosure. Therefore, the true scope of technical protection of the present disclosure should be defined by the technical spirit of the appended claims.

### INDUSTRIAL APPLICABILITY

Exemplary embodiments relate to a system and method for management of electronic fingerprint for preventing forgery or alteration of art pieces, a method for detecting forgery or alteration of art pieces and a computer program for the same. More particularly, exemplary embodiments relate to technology that converts a microstructure of a material used or to be used in an art piece into an electronic fingerprint, and prevents or detects forgery or alteration of the art piece using the electronic fingerprint.

1. A system for management of electronic fingerprint for preventing forgery or alteration of art pieces, comprising:
an imaging unit configured to image a microstructure from a portion of a material used or to be used in an art piece;
a fingerprint extraction unit configured to generate an electronic fingerprint including digital conversion information of the microstructure from the imaged microstructure; and
a fingerprint registration unit including a database, the fingerprint registration unit configured to generate a unique number corresponding to the electronic fingerprint, and register the electronic fingerprint and the unique number being associated with each other in the database.

2. (canceled)

3. The system for management of electronic fingerprint for preventing forgery or alteration of art pieces according to claim 1, wherein the imaging unit is configured to image the microstructure by irradiation of X-ray, ultrasonic wave or light of a preset brightness or more penetrating the material to a preset depth from a surface of the material.

4. The system for management of electronic fingerprint for preventing forgery or alteration of art pieces according to claim 1, wherein the digital conversion information of the microstructure includes a grid comprising a plurality of units each having a luminance value.

5. The system for management of electronic fingerprint for preventing forgery or alteration of art pieces according to claim 4, wherein the database is further configured to store encoded information of at least one of a location and size in which the microstructure is imaged, a size of the grid and a size of each unit of the grid.

6. (canceled)

7. A method for management of electronic fingerprint for preventing forgery or alteration of art pieces, comprising:
imaging, by a system for management of electronic fingerprint, a microstructure from a portion of a material used or to be used in an art piece;
generating, by the system for management of electronic fingerprint, an electronic fingerprint including digital conversion information of the microstructure from the imaged microstructure;
generating, by the system for management of electronic fingerprint, a unique number corresponding to the electronic fingerprint; and
registering the electronic fingerprint and the unique number being associated with each other in a database of the system for management of electronic fingerprint.

8. (canceled)

9. The method for management of electronic fingerprint for preventing forgery or alteration of art pieces according to claim 7, wherein imaging the microstructure comprises imaging the microstructure by irradiation of X-ray, ultrasonic wave or light of a preset brightness or more penetrating the material to a preset depth from a surface of the material.

10. The method for management of electronic fingerprint for preventing forgery or alteration of art pieces according to claim 7, wherein the digital conversion information of the microstructure includes a grid comprising a plurality of units each having a luminance value.

11. The method for management of electronic fingerprint for preventing forgery or alteration of art pieces according to claim 10, wherein registering in the database comprises storing encoded information of at least one of a location and size in which the microstructure is imaged, a size of the grid and a size of each unit of the grid in the database.

12. (canceled)

13. A computer program stored in a medium to perform the method for management of electronic fingerprint for preventing forgery or alteration of art pieces according to claim 7, in combination with hardware.

14. A system for management of electronic fingerprint for preventing forgery or alteration of art pieces, comprising:
a fingerprint registration unit including a database, wherein an electronic fingerprint including digital conversion information of a microstructure of a portion of a material used or to be used in an art piece and a unique number of the electronic fingerprint are associated with each other and stored in the database;
a communication unit to receive information read from a material used in a target art piece or a Near Field Communication (NFC) tag fixed to the material; and
a forgery and alteration detection unit configured to compare the information received by the communication unit with the information stored in the database,
wherein the communication unit is further configured to transmit a result of the comparison by the forgery and alteration detection unit to a user device as information indicating authenticity of the target art piece.

15. The system for management of electronic fingerprint for preventing forgery or alteration of art pieces according to claim 14, wherein the information received by the communication unit includes the unique number read from the material.

16. The system for management of electronic fingerprint for preventing forgery or alteration of art pieces according to claim 14, wherein the information received by the communication unit includes at least one of the unique number and the electronic fingerprint read from the NFC tag.

17. The system for management of electronic fingerprint for preventing forgery or alteration of art pieces according to claim 16, wherein the database further stores art piece information associated with the electronic fingerprint and the unique number,
the information received by the communication unit further includes art piece information read from the NFC tag, and
the forgery and alteration detection unit is further configured to compare the art piece information read from the NFC tag with the art piece information stored in the database.

18. The system for management of electronic fingerprint for preventing forgery or alteration of art pieces according to claim 16, wherein the forgery and alteration detection unit is further configured to compare the electronic fingerprint read from the NFC tag with the electronic fingerprint stored in the database.

19. (canceled)

20. A method for detecting forgery or alteration of art pieces, comprising:
receiving, by a system for management of electronic fingerprint, information read from a material used in a target art piece or a Near Field Communication (NFC) tag fixed to the material;
comparing the information received by the system for management of electronic fingerprint with information stored in a database of the system for management of electronic fingerprint, wherein an electronic fingerprint including digital conversion information of a microstructure of a portion of a material used or to be used in an art piece and a unique number of the electronic fingerprint are associated with each other and stored in the database; and
transmitting a result of the comparison to a user device as information indicating authenticity of the target art piece.

21. The method for detecting forgery or alteration of art pieces according to claim 20, wherein the receiving comprises receiving the unique number read from the material.

22. The method for detecting forgery or alteration of art pieces according to claim 20, wherein the receiving comprises receiving at least one of the unique number and the electronic fingerprint read from the NFC tag.

23. The method for detecting forgery or alteration of art pieces according to claim 22, wherein the database further stores art piece information associated with the electronic fingerprint and the unique number,
the receiving comprises receiving art piece information read from the NFC tag, and
the comparing comprises comparing the art piece information read from the NFC tag with the art piece information stored in the database.

24. The method for detecting forgery or alteration of art pieces according to claim 22, wherein the comparing comprises comparing the electronic fingerprint read from the NFC tag with the electronic fingerprint stored in the database.

25. (canceled)

26. A computer program stored in a medium to perform the method for detecting forgery or alteration of art pieces according to claim 20, in combination with hardware.
